(19) United States
(12) Patent Application Publication
(10) Pub. No.: US 2015/0160028 A1
(43) Pub. Date: Jun. 11, 2015

(54) PRESENTING INFORMATION ON A MAP

(71) Applicant: GOOGLE INC., (US)

(72) Inventors: Emma Burrows, Zurich (CH); Andrew J. McCarthy, Zurich (CH); Konrad Gianno, Forch (CH); Stefan H. Pharies, Zurich (CH); Amar Singh Sagoo, Thalwil (CH); Bjoern Kolbeck, Zurich (CH); Jiri Semecky, Adliswil (CH); Domenico Carbotta, Zurich (CH); Emmanuel Francois-David Pellereau, Benglen (CH)

(21) Appl. No.: 13/645,306

(22) Filed: Oct. 4, 2012

(51) Int. Cl. G01C 21/00; G01C 21/34; G01C 21/36

(52) U.S. Cl. CPC G01C 21/3423; G01C 21/3492; G01C 21/3679; G01C 21/3484

(57) ABSTRACT

Methods, systems, and apparatus, including computer programs encoded on a computer storage medium, for receiving user input specifying a location and a threshold time; determining, based on the specified location and the threshold time, a first reachable area, first transport hubs located within the first reachable area, and respective first shortest times for reaching the first transport hubs from the specified location; determining, for each of the first transport hubs, and based on the threshold time and the respective first shortest times, second transport hubs that are reachable from the specified location, and respective second shortest times for reaching the second transport hubs from the specified location; determining, for each of the second transport hubs, and based on the threshold time and the respective second shortest times, respective second reachable areas; determining a combined reachable area; and providing data describing the combined reachable area for display.

### BACKGROUND

This specification relates to presenting information relative to a map.

Users can use maps of geographic regions to identify travel routes. Conventionally, a user can make travel plans using hardcopy or web-based maps of a geographic location. In some instances, users can use web sites containing web-based maps to identify an itinerary for travel (e.g., a particular travel route) or hotel locations.

### SUMMARY

Geographic areas that are reachable from a specified location within a specified time limit can be identified. Whether a geographic area is reachable from the specified location within the time limit can be determined based on different transport options, e.g., walking or public transit. In determining reachability, a first reachable geographic area is determined, e.g., a distance that can be walked from the specified location within the time limit. One or more first transport hubs, e.g., train stations, that are located within the first reachable geographic area are identified. Next, one or more second transport hubs, e.g., interconnected train stations, that are reachable from the first transport hubs within the time limit are identified. Based on the second transport hubs and the remaining time limit, geographic areas that are reachable from the second transport hubs are determined.

Hotels that are located within the identified geographic areas can be identified. For each of the identified hotels, a further determination can be made to select hotels that can be reached from the specified location within the remaining time limit. Alternatively, a particular hotel can be used as the specified location and geographic areas that are reachable from the hotel, including points of interests located within the geographic areas, can be identified.

In general, one aspect of the subject matter described in this specification can be embodied in methods that include the actions of receiving, through a client device, user input specifying a location and a threshold transit time; determining, based on the specified location and the threshold transit time, a first reachable geographic area, one or more first transport hubs located within the first reachable geographic area, and respective first shortest transit times for reaching the one or more first transport hubs from the specified location; determining, for each of the one or more first transport hubs, and based on the threshold transit time and the respective first shortest transit times, one or more second transport hubs that are reachable from the specified location, and respective second shortest transit times for reaching the one or more second transport hubs from the specified location; determining, for each of the one or more second transport hubs, and based on the threshold transit time and the respective second shortest transit times, respective second reachable geographic areas; determining a combined reachable geographic area based on the first reachable geographic area and the respective second reachable geographic areas; and providing data describing the combined reachable geographic area to the client device for display. Other embodiments of this aspect include corresponding systems, apparatus, and computer program products.

These and other embodiments can optionally include one or more of the following features. The first reachable geographic area is determined based on a travel distance originating from the specified location, and wherein the travel distance is based on a transit speed and the threshold transit time. A respective second reachable geographic area is determined based on a travel distance originating from a respective second transport hub, and where the travel distance is based on a transit speed, the threshold transit time, and the respective second shortest transit times. A respective first shortest transit time for reaching a first transport hub from the specified location is determined based on transit times for one or more paths from the specified location to the first transport hub. A respective second shortest transit time for reaching a second transport hub from the specified location is determined based on transit times for one or more paths from the specified location to the first transport hubs and transit times for one or more paths from the first transport hubs to the second transport hub.

The method further includes providing an index to the client device for use in determining a listing of hotels that are reachable from the specified location within the threshold transit time. The method further includes identifying one or more hotels located within the combined reachable geographic area; determining, for each of the one or more identified hotels, a respective shortest transit time for reaching the identified hotel from the specified location; determining a hotel listing based on the respective shortest transit times and the threshold transit time; and providing the hotel listing to the client device. The method further includes receiving user input adjusting the threshold transit time; and adjusting the combined reachable geographic area based on the threshold transit time. The method further includes identifying one or more hotels located within the adjusted combined reachable geographic area; determining, for each of the one or more identified hotels, a respective shortest transit time for reaching the identified hotel from the specified location; determining a second hotel listing based on the respective shortest transit times and the adjusted threshold transit time; and providing the second hotel listing to the client device.

Particular embodiments of the subject matter described in this specification can be implemented so as to realize one or more of the following advantages. A geographic area representing an area that is reachable from a specified location can be determined. The geographic area can be displayed on a map to indicate regions that are reachable from the specified location within a threshold transit time. A listing of hotels that are located within the geographic area and are reachable from the specified location within the threshold transit time can be determined. The geographic area can be determined based on different transport options, e.g., walking or public transit.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example search system.

FIG. 2 is a block diagram of an example index describing data collected by a system.

FIG. 3 is a flow diagram of an example process for determining areas that are reachable from a location.

FIG. 4 is an example hotel results listing including reachability map.

FIG. 5 is an example reachability map showing areas that are reachable from a specified location within a threshold transit time.

FIG. 6 is an example reachability map showing areas that are reachable from the specified location within a different threshold transit time.

FIG. 7 is an example illustration of determining reachable areas from a specified location.

Like reference numbers and designations in the various drawings indicate like elements.

### DETAILED DESCRIPTION

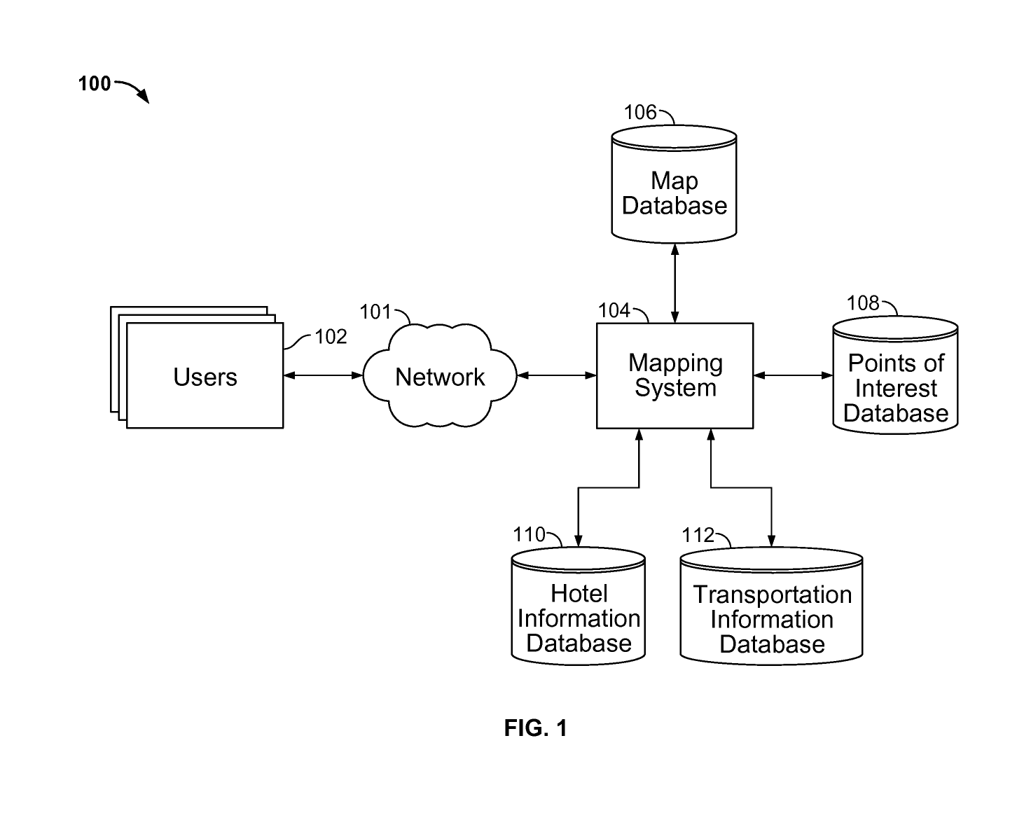

FIG. 1 is a block diagram of an example search system 100. The search system 100 includes a mapping system 104 in communication with one or more users 102 through a network 101. The mapping system 104 receives information from a map database 106 to display maps for geographic regions. The map database 104 can store, for example, data describing different types of maps for geographic regions, e.g., two-dimensional maps, three-dimensional maps, or satellite maps. The system can identify geographic locations on maps obtained from the map database 106 based on specified location information, e.g., a zip code, geographic coordinates, street address, name of a city, state, country, continent, or point of interest. The mapping system 104 can also use the data provided by the map database 106 to calculate distances for one or more routes between two geographic locations. The distances can be measured based on metric units, English units, or time, e.g., an estimated amount of time to reach a second location from a first location based on a specified travel speed.

The mapping system 104 can communicate with a hotel database 110 to obtain hotel information describing hotels in various geographic regions, corresponding pricing information, dates of availability, locations, descriptions, amenities, rating classes, and reviews. In particular, the mapping system 104 can identify one or more hotels that are located near a particular location within a geographic region. For example, the mapping system 104 can identify one or more hotels that are located within a specified distance from a particular location. In some implementations, the mapping system 104 identifies one or more hotels locations that are reachable from a particular location within a specified transit time, as described below. The term “hotel” as used in the specification can refer generically to various types of accommodations including hotels, motels, lodges, or resorts.

The mapping system 104 can communicate with a transportation information database 112 to obtain data describing locations of transport hubs, e.g., train stations, in a geographic region. The data can also identify, for each transport hub, transport options, e.g., trains, that are available at the transport hub, destination transport hubs that are reachable from the transport hub, and respective transit times for reaching the destination transport hubs. The transport information database 112 can store data describing geographic locations of other types of transport hubs in a geographic region, e.g., bus stops and ferry ports, their respective transport options, reachable destination transport hubs, and transit times for reaching the destination transport hubs.

A destination transport hub may be directly reachable from a transport hub, e.g., a train runs from the transport hub to the destination transport hub. A destination transport hub may also be indirectly reachable from a transport hub. For example, a bus station can be reached from a train station by walking or driving from the train station to the bus station. In some cases, the destination transport hub may be indirectly reachable from the transport hub through one or more intermediary transport hubs. For any given case, the transport information database 112 can store data describing one or more ways of reaching a destination transport hub and corresponding transit times for reaching the destination transport hub from the transport hub.

The term “train” as used in the specification can refer generically to various types of mass transit rail systems, e.g., subways and metros. The term “bus” as used in the specification can refer generically to various types of mass public transit systems, e.g., shuttles.

The mapping system 104 can use the data available in the transportation information database 112 to determine a shortest transit time between two transport hubs. In some implementations, the shortest transit time is calculated based on average transit times for traveling from a first transport hub to a second transport hub. The shortest transit times can also be calculated based on average transit times for a particular day of the week, time of day, holiday, or real-time traffic data. In calculating the shortest transit time, the mapping system 104 considers all ways of reaching a first transport hub from the second transport hub. Shortest transit times between locations, e.g., transport hubs, can be determined using generally known techniques for calculating single-source shortest paths, e.g., Djikstra's algorithm.

For each transport hub, the mapping system 104 can store, in an index, data describing a transport hub, destination transport hubs that are reachable from the transport hub, and shortest transit times from the transport hub to the respective destination transport hubs. For example, for a transport hub, e.g., a train station S1, the mapping system 104 can store, in an index, data describing one or more destination transport hubs, e.g., train stations S3, S4, and bus station B1, and respective shortest transit times from the transport hub S1 to the destination transport hubs, e.g., 3 minutes, 10 minutes, and 25 minutes. In some implementations, the mapping system 104 stores, in the index, data describing a transport hub, destination transport hubs that are reachable from the transport hub, and shortest transit times from the transport hub to the respective destination transport hubs based on a given day and/or time. In some implementations, the index stores, for each first transport hub, data describing destination transport hubs that are reachable within 60 minutes.

The network 101 can be a local area network (LAN), a wide area network (WAN), the Internet, one or more telephony or wireless networks, or a combination thereof.

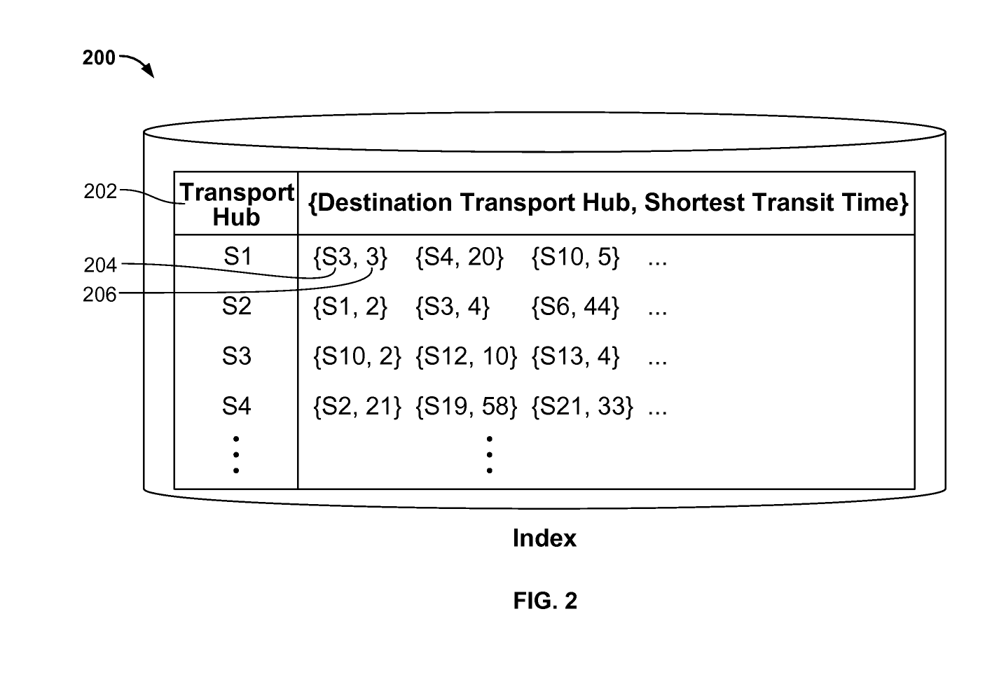

FIG. 2 is a block diagram of an example index 200 describing data collected by a system, e.g., the mapping system 104. In some implementations, the index 200 stores data describing a transport hub 202, destination transport hubs 204 that are reachable from the transport hub 202, and respective shortest transit times 206 from the transport hub 202 to the destination transport hubs 204.

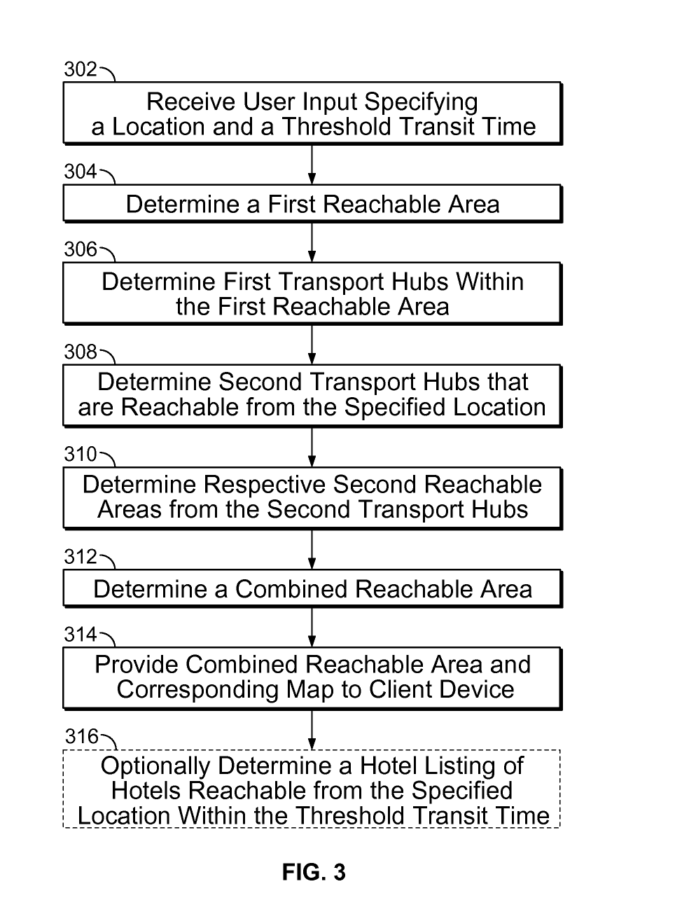

FIG. 3 is a flow diagram of an example process 300 for determining areas that are reachable from a location. For convenience, the process 300 will be described with respect to a system, e.g., search system 100, including one or more computing devices that performs the process 300.

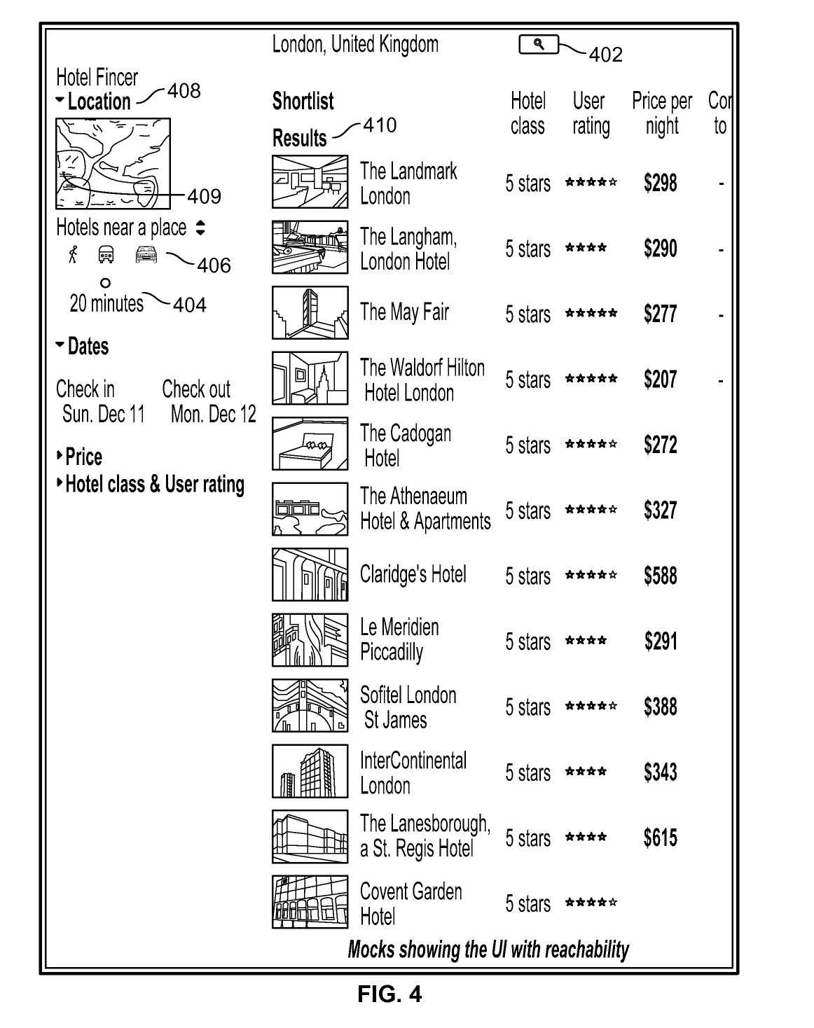

The system receives user input specifying a location and a threshold transit time (302). The user input can be received from a client device communicating over a network. The user input can be specified in a graphical user interface (GUI), e.g., the GUI described below in reference to FIG. 4. The system can identify a geographic position for the specified location on a map, as described in reference to FIG. 1. In some implementations, when the user input specifies the location as the name of a city, the system identifies the specified location as the city center of the city.

The system determines a first reachable geographic area from the specified location (304). In some implementations, the system determines a first reachable geographic area from the specified location by defining an area, e.g., a circular region, centered on the specified location. The circular region can be calculated using a travel distance radius that estimates a distance that is reachable from the specified location based on a transit speed and the threshold transit time.

To calculate the travel distance radius, the system determines a distance that is reachable from the specified location within the threshold transit time. The distance is based on one or more transit speeds. For example, the system can determine, based on a walking speed of 3 kilometers per hour and a threshold transit time of 30 minutes, a travel distance radius of 1.5 kilometers. Based on this travel distance radius, the system can identify a circular region that represents a reachable geographic region around the specified location, e.g., a circular region around the specified location having a 1.5 kilometer radius.

In some implementations, the transit speed used in calculating the travel distance radius is based on a predetermined walking speed, e.g., 3 kilometers per hour. In some implementations, the transit speed is based on a specified transit method, e.g., driving or bicycling. In some implementations, the transit speed is specified by a user.

The system determines one or more first transport hubs that are located within the first reachable geographic area (306). Transport hubs can be determined as described, for example, in FIG. 1. For each of the first transport hubs, the system can also determine a respective shortest transit time for reaching the first transport hub from the specified location. In calculating the shortest transit time between the specified location and a first transport hub, the system considers a time cost of directly traveling, e.g., walking, to the first location. The system can also consider a time cost of traveling to the first location using one or more intermediary transport hubs, e.g., walking from the specified location to a train station S1, and taking a train from the train station S1 to the train station S3.

The system determines one or more second transport hubs that are reachable from the specified location based on the threshold transit time (208). In some implementations, the system identifies a collection of destination transport hubs that are reachable from the first transport hubs and respective shortest transit times for reaching the destination transport hubs from the first transport hubs. The system can identify destination transport hubs and transit times using an index, e.g., the index described in reference to FIG. 2.

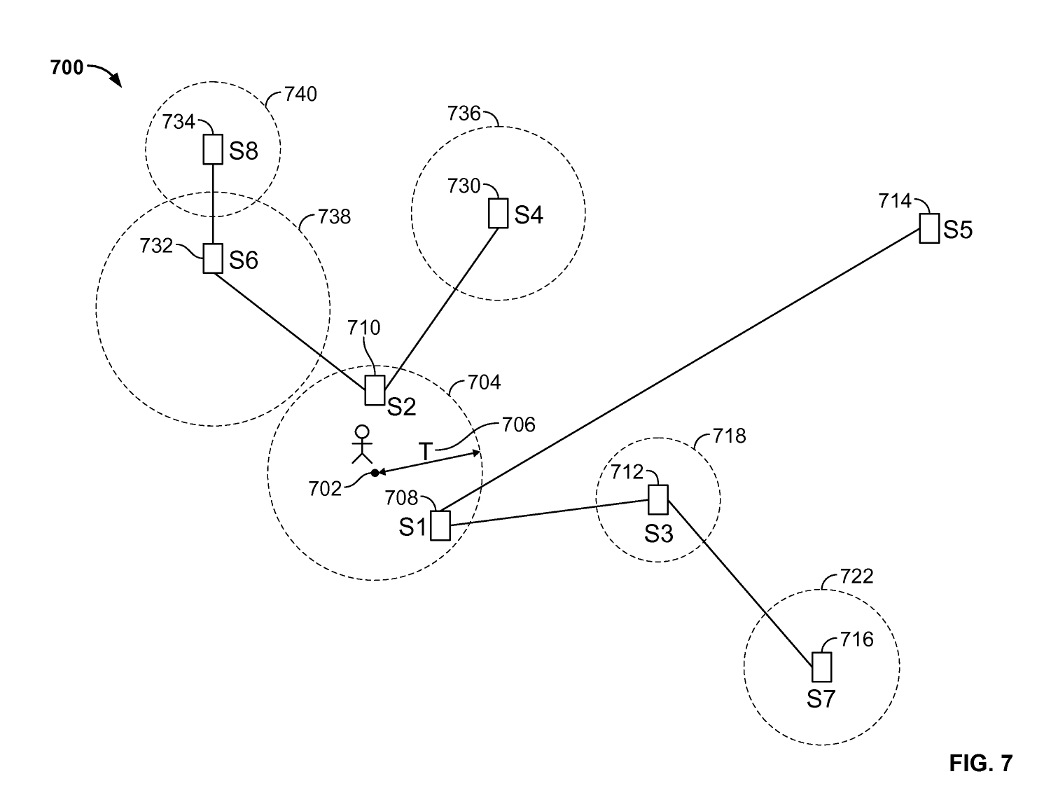

The system identifies, from the collection of destination transport hubs, second transport hubs that are reachable from the specified location within the threshold transit time. In identifying a second transport hub, the system determines whether a time cost for reaching the second transport hub from the specified location is within the threshold transit time. In some implementations, the time cost is based on a sum of a shortest transit time for reaching a first transport hub from the specified location and a shortest transit time for reaching the second transport hub from the first transport hub. First transport hubs, destination transport hubs, and second transport hubs are further described in reference to FIG. 7.

For each of the second transport hubs, the system also determines a shortest transit time for reaching the second transport hub from the specified location. In determining a shortest transit time for the second transport hubs, the system considers the transit times for all paths from the specified location to the first transport hubs and the transit times for all paths from the first transport hubs to the second transport hub.

The system determines respective reachable geographic areas from the one or more second transport hubs (310). In some implementations, the system determines respective reachable geographic areas from the second transport hubs by defining an area, e.g., a circular region, around each of the second transport hubs. Each respective circular region can be calculated using a travel distance radius that estimates a distance that is reachable from a second transport hub that is within the threshold transit time based on the transit speed. In determining whether the reachable distance from a second transport hub is within the threshold transit time, the system factors in a time cost for reaching the second transport hub from the specified location. In other words, the sum of a time cost for traveling the reachable distance from a second transport hub and the time cost for reaching the second transport hub from the specified location should not exceed the threshold transit time.

The system determines a combined reachable geographic area (312). The system can merge the reachable geographic areas defined for each of the second transport hubs and the first reachable geographic area into data describing a combined reachable geographic area.

The system provides data describing the combined reachable area and a corresponding map that encompasses the combined reachable area to the client device (314). The client device can display the map and the combined reachable area to indicate areas that are reachable from the specified location within the threshold transit time.

In some implementations, data describing the second transport hubs and respective shortest transit times for reaching the second transport hubs from the specified location are provided to the client device. In such implementations, the user can adjust the threshold transit time, e.g., using a transit time filter as described in reference to FIG. 4. In response to adjusting the threshold transit time, the client device can use the data to identify transport hubs that are reachable from the specified location within the adjusted threshold transit time. The client device can also use the data to determine respective reachable geographic areas from the second transport hubs and a combined reachable geographic area, as described above.

The system optionally determines a listing of hotels reachable from the specified location within the threshold transit time (316). In some implementations, the system determines an index of hotels located in a geographic region. The system can use the index to identify hotels that are reachable from the specified location within the threshold transit time. In such implementations, the system constructs the index by identifying hotels that are located within the combined reachable geographic area. For each identified hotel, the system determines a hotel time cost for reaching the hotel from the specified location. In some implementations, the hotel time cost is determined based on a sum of a shortest transit time for reaching the hotel from a second transport hub and a shortest transit time for reaching the second transport hub from the specified location.

In some implementations, the system uses the index to determine a listing of hotels that are reachable from the specified location within the threshold transit time. The user can adjust the threshold transit time and, in response, the system can revise the hotel listing to display listings of hotels that are reachable within the adjusted threshold transit time. In determining reachable hotels, the system can compare each hotel's respective hotel time cost with the adjusted threshold transit time to identify hotels that have a respective hotel time cost that is within the adjusted threshold transit time.

In some other implementations, the index of hotels is provided to the client device and the client device uses the index to determine a listing of hotels that are reachable from the specified location within the threshold transit time. The client device can respond to user adjustments to the threshold transit time by determining an updated listing of hotels that are reachable from the specified location within the adjusted threshold transit time.

Alternatively, the system provides the index to the client device for display as a hotel listing. The user can adjust the threshold transit time and, in response to the adjustment, the client device can revise the hotel listing to display listings of hotels that are reachable within the adjusted threshold transit time. In determining reachable hotels, the client device can compare each hotel's respective hotel time cost with the adjusted threshold transit time to identify hotels that have a respective hotel time cost that is within the adjusted threshold transit time.

In some implementations, the user can specify one or more additional locations and the system can determine an aggregate combined reachable area that represents a reachable geographic area from all specified locations within the threshold transit time. The system can independently determine a combined reachable area for each specified location, as described above, and calculate an aggregate combined reachable area for the specified locations based on an intersection of the independently determined combined reachable areas for each specified location.

A particular hotel can be specified as the specified location, together with a threshold transit time, and the system can use the process 300 to determine areas that are reachable from the particular hotel within the threshold transit time. In some implementations, the system identifies one or more points of interests that are located within the areas that are reachable from the particular hotel within the threshold transit time.

In some implementations, the system builds an index, e.g., the index 200 as described in reference to FIG. 2, and stores the index in memory, e.g., random access memory (“RAM”). In such implementations, when the system receives, through a client device, user input specifying a location, the system determines an index that identifies hotels that are reachable from the specified location within a threshold transit time. The system communicates the index of hotels to the client device. The client device can use the index to filter and display listings of hotels that are reachable within a specified threshold transit time.

FIG. 4 is an example hotel results listing 400 including reachability map 408. The reachability map 408 displays an area that is reachable 409 from a location that was specified in a search box 402. The reachable area 409 is determined based on a threshold transit time 404 and a transport option 406. The threshold transit time can be specified by value or by adjusting a sliding scale 404. FIG. 4 also includes a hotel results listing 410 includes a list of hotels including hotel name, snippets of corresponding hotel reviews, class, e.g., star level rating, user rating, relative price, and price per night.

In some implementations, the transport option is walking and the reachable area is determined by defining an area, e.g., a circular region, around the specified location, as described above. In some implementations, the transport option is driving and the reachable area is determined based on a default driving speed. Alternatively, when the transport option is driving, the system can compute reachable areas using intersections between major roads or highways as transport hubs. In some implementations, the system identifies important intersections by evaluating the amount of traffic that travels through the respective intersections over a particular time period, e.g., hour, day, month, or year. In some implementations, the transport option is public transit and the reachable area is determined by calculating a combined reachable area, as described above.

In some implementations, the transport option is automatically selected by the system based on a city corresponding to the specified location. In some implementations, the transport option is automatically selected by the system based on a threshold percentage of previous queries specifying a particular transport option for a city corresponding to the specified location. In some implementations, the transport option is automatically selected by the system based a threshold count of one or more of transport hubs and transport options.

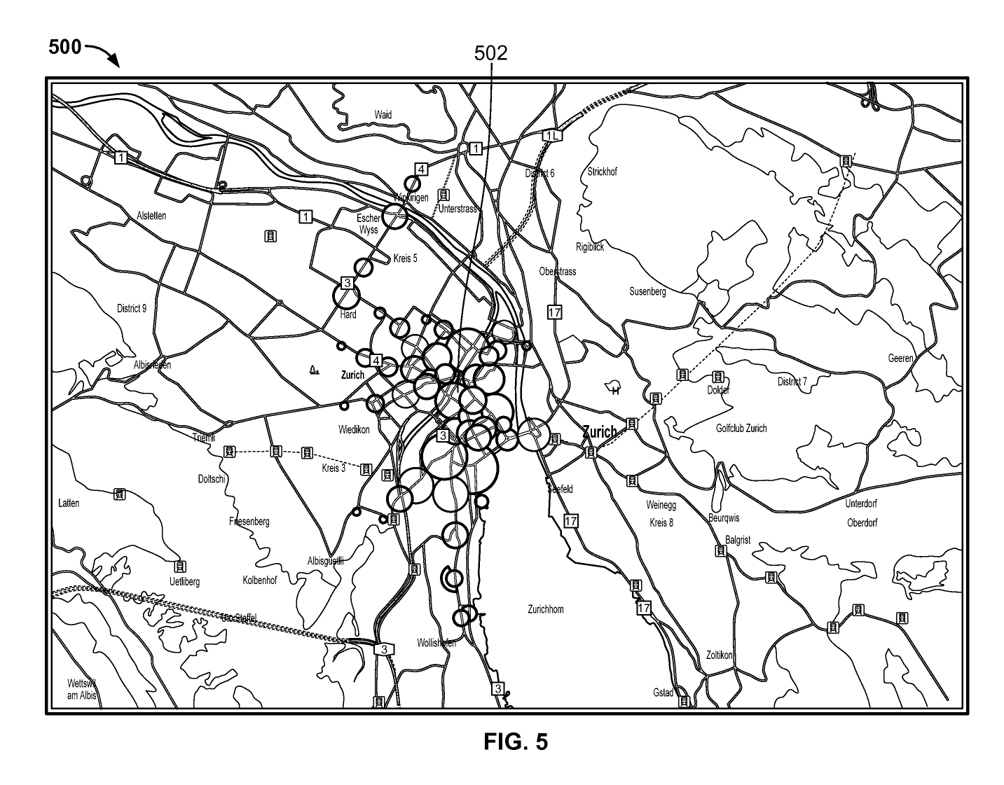

FIG. 5 is an example reachability map 500 showing areas 502 that are determined to be reachable from a specified location 502 within a threshold transit time. In FIG. 5, the reachability map 500 spotlights areas that are reachable from the specified location 502 within a first threshold transit time, e.g., 15 minutes. In contrast, areas that are unreachable from the specified location 502 within the first threshold transit time are shown without spotlighting.

In some implementations, data describing respective transit times from particular hotels to a point of interest are displayed in a map, e.g., the map 500, along with respective hotel indicators, as a way to provide users with a graphical interface for comparing hotel distances from the point of interest. In some implementations, data describing respective transit times from hotels to a particular point of interest is used when ranking hotels in relation to the particular point of interest.

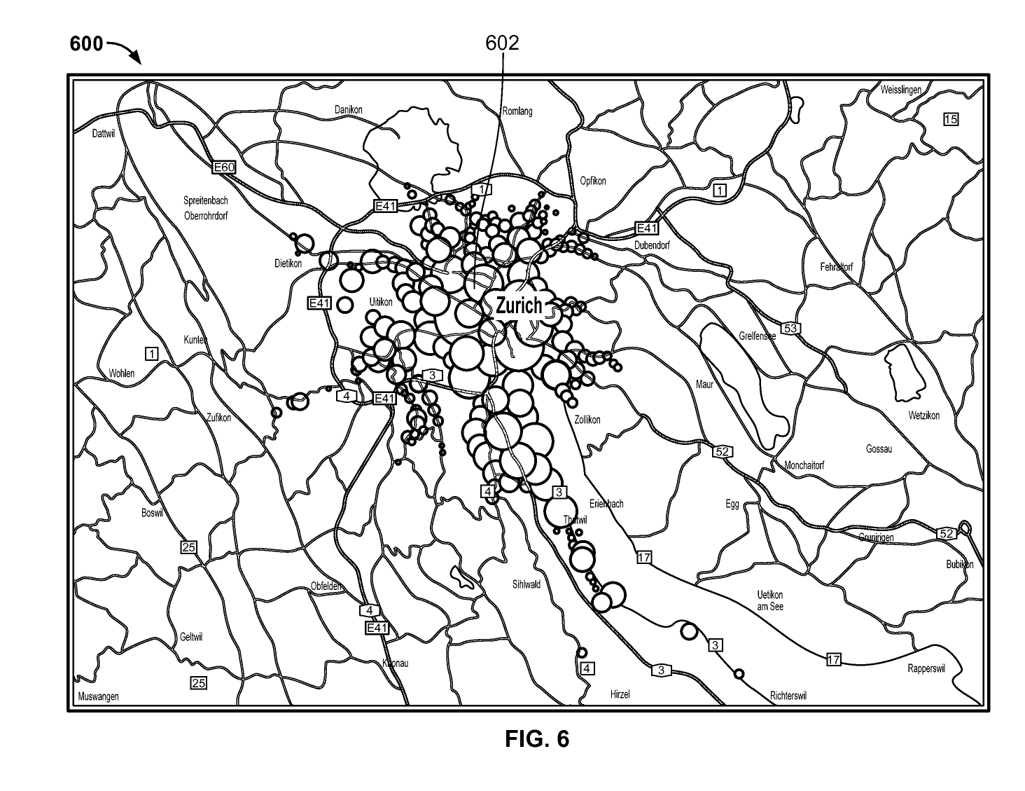

FIG. 6 is another example reachability map 600 showing areas 602 that are determined to be reachable from the specified location 602 within a different threshold transit time. In FIG. 6, the reachability map 600 spotlights areas that are reachable from the specified location 602 within a second threshold transit time, e.g., 30 minutes. In contrast to the reachability map 500 as described in reference to FIG. 5, the reachability map 600 shows a larger reachability area as a result of the threshold transit time being increased from 15 minutes to 30 minutes.

FIG. 7 is an example illustration of determining reachable areas from a specified location 702. Areas that are reachable from the specified location 702 can be determined using the process described in reference to FIG. 3. In FIG. 7, a first reachable geographic area 704 for a specified location 702 is determined based on a threshold transit time 706. The first reachable geographic area 704 represents, for example, an area that can be traveled, e.g., by walking, from the specified location within the threshold transit time 706. Next, first transport hubs 708 and 710 are identified within the first reachable geographic area 704.

Destination transport hubs are identified from each of the first transport hubs 708 and 710. In FIG. 7, destination transport hubs 712, 714, and 716 are identified for the first transport hub 708. Similarly, destination transport hubs 730, 732, and 734 are identified for the first transport hub 710.

Next, second transport hubs that are reachable from the specified location 702 are identified from the destination transport hubs based on the threshold transit time 706. In FIG. 7, destination transport hubs 712 and 716 are identified as second transport hubs that are reachable from the specified location 702 within the threshold transit time 706. In contrast, the destination transport hub 714 is not identified as a second transport hub because the amount of time needed to reach the destination transport hub 714 from the specified location 702 exceeds the threshold transit time 706. Similarly, destination transport hubs 730, 732, and 734 are identified as second transport hubs that are reachable from the specified location 702 within the threshold transit time 706. Next, respective reachable geographic areas 718, 722, 736, 738, and 740 are determined based on the second transport hubs 712, 716, 730, 732, and 734, and the threshold transit time 706. The reachable geographic areas 718, 722, 736, 738, and 740 represent areas that are reachable from the specified location 702 within the threshold transit time 706.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by a data processing apparatus, the method comprising:
receiving, through a client device, user input specifying a location and a threshold transit time;
determining, based on the specified location and the threshold transit time, a first reachable geographic area, one or more first transport hubs located within the first reachable geographic area, and respective first shortest transit times for reaching the one or more first transport hubs from the specified location;
receiving transportation information, for each of the one or more first transport hubs, including available transport options specific to each first transport hub and respective transit times for the available transport options;
determining, for each of the one or more first transport hubs, and based on the (i) threshold transit time, (ii) available transport options specific to the first transport hub, and (iii) respective first shortest transit times, one or more second transport hubs that are reachable from the specified location through a corresponding first transit hub, and respective second shortest transit times for reaching the one or more second transport hubs from the specified location through the corresponding first transit hub;
determining, for each of the one or more second transport hubs, and based on the threshold transit time and the respective second shortest transit times, respective second reachable geographic areas;
determining a combined reachable geographic area based on the first reachable geographic area and the respective second reachable geographic areas; and
providing data describing the combined reachable geographic area to the client device for display.

2. The method of claim 1, wherein the first reachable geographic area is determined based on a travel distance originating from the specified location, and wherein the travel distance is based on a transit speed and the threshold transit time.

3. The method of claim 1, wherein a respective second reachable geographic area is determined based on a travel distance originating from a respective second transport hub, and wherein the travel distance is based on a transit speed, the threshold transit time, and the respective second shortest transit times.

4. The method of claim 1, wherein a respective first shortest transit time for reaching a first transport hub from the specified location is determined based on transit times for one or more paths from the specified location to the first transport hub.

5. The method of claim 1, wherein a respective second shortest transit time for reaching a second transport hub from the specified location is determined based on transit times for one or more paths from the specified location to the first transport hubs and transit times for one or more paths from the first transport hubs to the second transport hub.

6. The method of claim 1, further comprising providing an index to the client device for use in determining a listing of hotels that are reachable from the specified location within the threshold transit time.

7. The method of claim 1, further comprising:
identifying one or more hotels located within the combined reachable geographic area;
determining, for each of the one or more identified hotels, a respective shortest transit time for reaching the identified hotel from the specified location;
determining a hotel listing based on the respective shortest transit times and the threshold transit time; and
providing the hotel listing to the client device.

8. The method of claim 1, further comprising:
receiving user input adjusting the threshold transit time; and
adjusting the combined reachable geographic area based on the threshold transit time.

9. The method of claim 8, further comprising:
identifying one or more hotels located within the adjusted combined reachable geographic area;
determining, for each of the one or more identified hotels, a respective shortest transit time for reaching the identified hotel from the specified location;
determining a second hotel listing based on the respective shortest transit times and the adjusted threshold transit time; and
providing the second hotel listing to the client device.

10. A system comprising:
a client device; and
one or more computers configured to interact with the client device and to perform operations comprising:
receiving, through a client device, user input specifying a location and a threshold transit time;
determining, based on the specified location and the threshold transit time, a first reachable geographic area, one or more first transport hubs located within the first reachable geographic area, and respective first shortest transit times for reaching the one or more first transport hubs from the specified location;
receiving transportation information, for each of the one or more first transport hubs, including available transport options specific to each first transport hub and respective transit times for the available transport options;
determining, for each of the one or more first transport hubs, and based on the (i) threshold transit time, (ii) available transport options specific to the first transport hub, and (iii) respective first shortest transit times, one or more second transport hubs that are reachable from the specified location through a corresponding first transport hub, and respective second shortest transit times for reaching the one or more second transport hubs from the specified location through the corresponding first transit hub;
determining, for each of the one or more second transport hubs, and based on the threshold transit time and the respective second shortest transit times, respective second reachable geographic areas;
determining a combined reachable geographic area based on the first reachable geographic area and the respective second reachable geographic areas; and
providing data describing the combined reachable geographic area to the client device for display.

11. The system of claim 10, wherein the first reachable geographic area is determined based on a travel distance originating from the specified location, and wherein the travel distance is based on a transit speed and the threshold transit time.

12. The system of claim 10, wherein a respective second reachable geographic area is determined based on a travel distance originating from a respective second transport hub, and wherein the travel distance is based on a transit speed, the threshold transit time, and the respective second shortest transit times.

13. The system of claim 10, wherein a respective first shortest transit time for reaching a first transport hub from the specified location is determined based on transit times for one or more paths from the specified location to the first transport hub.

14. The system of claim 10, wherein a respective second shortest transit time for reaching a second transport hub from the specified location is determined based on transit times for one or more paths from the specified location to the first transport hubs and transit times for one or more paths from the first transport hubs to the second transport hub.

15. The system of claim 10, further comprising providing an index to the client device for use in determining a listing of hotels that are reachable from the specified location within the threshold transit time.

16. The system of claim 10, further comprising:
identifying one or more hotels located within the combined reachable geographic area;
determining, for each of the one or more identified hotels, a respective shortest transit time for reaching the identified hotel from the specified location;
determining a hotel listing based on the respective shortest transit times and the threshold transit time; and
providing the hotel listing to the client device.

17. The system of claim 10, further comprising:
receiving user input adjusting the threshold transit time; and
adjusting the combined reachable geographic area based on the threshold transit time.

18. The system of claim 17, further comprising:
identifying one or more hotels located within the adjusted combined reachable geographic area;
determining, for each of the one or more identified hotels, a respective shortest transit time for reaching the identified hotel from the specified location;
determining a second hotel listing based on the respective shortest transit times and the adjusted threshold transit time; and
providing the second hotel listing to the client device.

19. A computer storage medium encoded with a computer program, the program comprising instructions that when executed by data processing apparatus cause the data processing apparatus to perform operations comprising:
receiving, through a client device, user input specifying a location and a threshold transit time;
determining, based on the specified location and the threshold transit time, a first reachable geographic area, one or more first transport hubs located within the first reachable geographic area, and respective first shortest transit times for reaching the one or more first transport hubs from the specified location;
receiving transportation information, for each of the one or more first transport hubs, including available transport options specific to each first transport hub and respective transit times for the available transport options;
determining, for each of the one or more first transport hubs, and based on the (i) threshold transit time, (ii) available transport options specific to the first transport hub, and (iii) respective first shortest transit times, one or more second transport hubs that are reachable from the specified location through a corresponding first transit hub, and respective second shortest transit times for reaching the one or more second transport hubs from the specified location through the corresponding first transit hub;
determining, for each of the one or more second transport hubs, and based on the threshold transit time and the respective second shortest transit times, respective second reachable geographic areas;
determining a combined reachable geographic area based on the first reachable geographic area and the respective second reachable geographic areas; and
providing data describing the combined reachable geographic area to the client device for display.

20. The computer storage medium of claim 19, wherein the first reachable geographic area is determined based on a travel distance originating from the specified location, and wherein the travel distance is based on a transit speed and the threshold transit time.

21. The computer storage medium of claim 19, wherein a respective second reachable geographic area is determined based on a travel distance originating from a respective second transport hub, and wherein the travel distance is based on a transit speed, the threshold transit time, and the respective second shortest transit times.

22. The computer storage medium of claim 19, wherein a respective first shortest transit time for reaching a first transport hub from the specified location is determined based on transit times for one or more paths from the specified location to the first transport hub.

23. The computer storage medium of claim 19, wherein a respective second shortest transit time for reaching a second transport hub from the specified location is determined based on transit times for one or more paths from the specified location to the first transport hubs and transit times for one or more paths from the first transport hubs to the second transport hub.

24. The computer storage medium of claim 19, further comprising providing an index to the client device for use in determining a listing of hotels that are reachable from the specified location within the threshold transit time.

25. The computer storage medium of claim 19, further comprising:
identifying one or more hotels located within the combined reachable geographic area;
determining, for each of the one or more identified hotels, a respective shortest transit time for reaching the identified hotel from the specified location;
determining a hotel listing based on the respective shortest transit times and the threshold transit time; and
providing the hotel listing to the client device.

26. The computer storage medium of claim 19, further comprising:
receiving user input adjusting the threshold transit time; and
adjusting the combined reachable geographic area based on the threshold transit time.

27. The computer storage medium of claim 26, further comprising:
identifying one or more hotels located within the adjusted combined reachable geographic area;
determining, for each of the one or more identified hotels, a respective shortest transit time for reaching the identified hotel from the specified location;
determining a second hotel listing based on the respective shortest transit times and the adjusted threshold transit time; and
providing the second hotel listing to the client device.
